(19) United States
(12) Patent Application Publication
(10) Pub. No.: US 2024/0396082 A1
(43) Pub. Date: Nov. 28, 2024

(54) BATTERY CELLS INCLUDING HIGH VOLTAGE CATHODE ELECTRODES WITH ENHANCED CYCLING CAPABILITY

(71) Applicant: GM GLOBAL TECHNOLOGY OPERATIONS LLC, Detroit, MI (US)

(72) Inventors: Chuanlong WANG, Troy, MI (US); Lei Wang, Rochester Hills, MI (US); Xiaosong Huang, Novi, MI (US)

(21) Appl. No.: 18/323,744

(22) Filed: May 25, 2023

(51) Int. Cl. H01M 10/0567; H01M 10/052; H01M 10/0569

(52) U.S. Cl. CPC H01M 10/0567; H01M 10/052; H01M 10/0569; H01M 2300/0034; H01M 2300/0037

(57) ABSTRACT

A battery cell comprises C cathode electrodes comprising a cathode current collector and a cathode active material layer, where C is an integer greater than zero, A anode electrodes comprising an anode current collector and an anode active material layer, where A is an integer greater than zero, and S separators, where S is an integer greater than zero. An electrolyte comprising an additive including at least one of tris(2,2,2-trifluoroethyl) phosphate (TFEP) and a TFEP derivative.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to battery cells including high voltage cathode electrodes with enhanced cycling capability.

Electric vehicles (EVs) such as battery electric vehicles (BEVs), hybrid vehicles, and/or fuel cell vehicles include one or more electric machines and a battery system including one or more battery cells, modules and/or packs. A battery control module is used to control charging and/or discharging of the battery system during charging and/or driving. Manufacturers of EVs are pursuing increased power density to increase the range of the EVs.

### SUMMARY

A battery cell comprises C cathode electrodes comprising a cathode current collector and a cathode active material layer, where C is an integer greater than zero, A anode electrodes comprising an anode current collector and an anode active material layer, where A is an integer greater than zero, and S separators, where S is an integer greater than zero. An electrolyte comprising an additive including at least one of tris(2,2,2-trifluoroethyl) phosphate (TFEP) and a TFEP derivative.

In other features, the electrolyte further comprises lithium hexafluorophosphate (LiPF₆). The LiPF₆ comprises 0.5 to 1.5 Molar per liter LiPF₆. The electrolyte further comprises fluoroethylene carbonate (FEC). The electrolyte further comprises diethyl carbonate (DEC). The electrolyte includes a ratio of FEC to DEC in a range from 1:1 to 1:9. The electrolyte comprises 0.5 wt % to 2.5 wt % of the at least one of TFEP and the TFEP derivative. The TFEP derivative includes phosphate with one or more linear fluorinated side groups.

In other features, the one or more linear fluorinated side groups include one or more materials selected from a group consisting of tris(2,2,3,3,3-pentafluoropropyl) phosphate, bis(2,2,2-trifluoroethyl) methyl phosphonate, and methyl P,P-bis(2,2,2-trifluoroethyl) phosphonoacetate. The anode active material layer comprises graphite and one or more materials selected from a group consisting of silicon, silicon/carbon composite, silicon oxide, and lithium silicon oxide. The C cathode electrodes have an operating voltage greater than or equal to 4.2V.

In other features, the cathode active material layer includes one or more materials selected from a group consisting of lithium and manganese-rich (LMR) particles and lithium nickel manganese oxide (LNMO) particles. The electrolyte further comprises 0.5 wt % to 1.5 wt % LiPO₂F₂.

An electrolyte comprises lithium hexafluorophosphate (LiPF₆); fluoroethylene carbonate (FEC); diethyl carbonate (DEC); and an additive including at least one of tris (2,2,2-trifluoroethyl) phosphate (TFEP) and a TFEP derivative.

In other features, the LiPF₆ comprises 0.5 to 1.5 molar per liter LiPF₆. The electrolyte includes a ratio of FEC to DEC in a range from 1:1 to 1:9. The electrolyte comprises 0.5 wt % to 2.5 wt % of the at least one of TFEP and the TFEP derivative.

The TFEP derivative includes phosphate with one or more linear fluorinated side groups. The one or more linear fluorinated side groups include one or more materials selected from a group consisting of tris(2,2,3,3,3-pentafluoropropyl) phosphate, bis(2,2,2-trifluoroethyl) methyl phosphonate, and methyl P,P-bis(2,2,2-trifluoroethyl) phosphonoacetate. The electrolyte further comprises 0.5 wt % to 1.5 wt % LiPO₂F₂.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross section of a battery cell according to the present disclosure;

FIGS. 2 and 3 are graphs illustrating areal capacity and normalized capacity retention, respectively, as a function of a number of cycles for various electrolyte mixtures according to the present disclosure; and

FIGS. 4 and 5 are graph illustrating areal capacity and normalized capacity retention, respectively, as a function of a number of cycles for various electrolyte mixtures according to the present disclosure;

In the drawings, reference numbers may be reused to identify similar and/or identical elements.

### DETAILED DESCRIPTION

While the battery cells according to the present disclosure are described in the context of electric vehicles, the battery cells can be used in stationary applications and/or in other types of applications.

Battery cells include anode electrodes, cathode electrodes, and separators arranged in a predetermined sequence in an enclosure of the battery cell. The anode electrodes include an anode current collector and a layer including anode active material arranged on one or both sides of the anode current collector. The cathode electrodes include a cathode current collector and a layer including cathode active material arranged on one or both sides of the cathode current collector. The separators are arranged between the anode and cathode electrodes in the enclosure. The enclosure also includes electrolyte.

The present disclosure relates to battery cells including high voltage cathode electrodes and an electrolyte including an additive comprising tris(2,2,2-trifluoroethyl) phosphate (TFEP) (and/or one or more TFEP derivatives). During operation, the TFEP additive in the electrolyte scavenges oxygenated species and forms a stable interphase, which improves the cycling stability of battery cells including high voltage cathode electrodes such as lithium-and-manganese-rich (LMR) cathodes.

In some examples, the cathode active material includes a high voltage cathode material. In some examples, the cathode active material layer may include lithium-and manganese-rich (LMR) cathode active material.

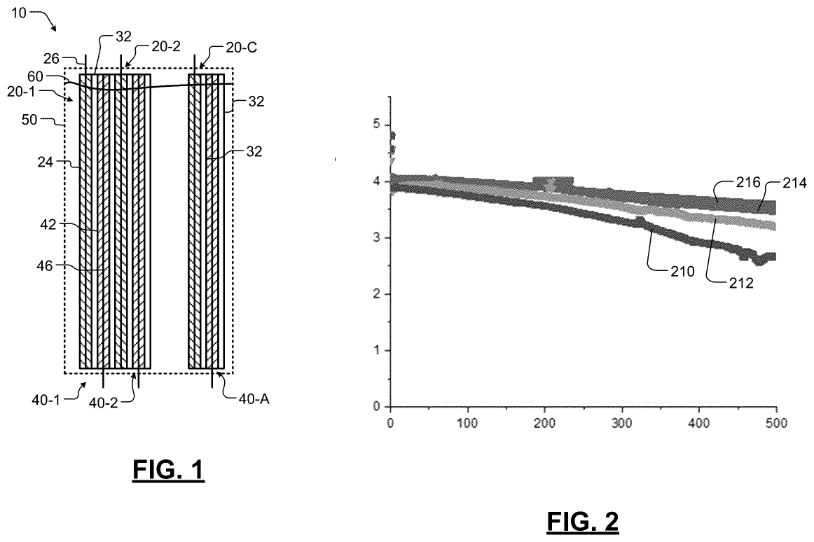

Referring now to FIG. 1, a battery cell 10 includes cathode electrodes 20-1, 20-2, . . . , and 20-C, where C is an integer greater than one. The cathode electrodes 20 include a cathode active material layer 24 arranged on one or both sides of cathode current collectors 26. The battery cell 10 includes anode electrodes 40-1, 40-2, . . . , and 40-A, where A is an integer greater than one. The anode electrodes 40 include an anode active material layer 42 arranged on one or both sides of anode current collectors 46. The cathode electrodes 20, the anode electrodes 40 and the separators 32 are arranged in a predetermined order in an enclosure 50. For example, separators 32 are arranged between the cathode electrodes 20 and the anode electrodes 40.

Electrolyte 60 is arranged in the enclosure 50. In some examples, the electrolyte 60 comprises an additive including TFEP (and/or one or more TFEP derivatives). In some examples, the electrolyte 60 comprises lithium hexafluorophosphate (LiPF₆), fluoroethylene carbonate (FEC), diethyl carbonate (DEC), and TFEP (and/or one or more TFEP derivatives). In some examples, the electrolyte 60 includes 0.5M to 1.5M LiPF₆ (e.g., 1.2M LiPF₆). In some examples, the FEC:DEC in the electrolyte 60 has a ratio in a range from 1:1 to 1:9 (e.g., 1:4). In some examples, the electrolyte 60 comprises 1.2 wt % to 2.5 wt % of TFEP (and/or one or more TFEP derivatives).

In other examples, the electrolyte 60 further comprises LiPF₆, FEC, DEC, lithium difluorophosphate (LiPO₂F₂), and TFEP (and/or one or more TFEP derivatives). In some examples, the electrolyte 60 includes 0.5M to 1.5M LiPF₆ (e.g., 1.2M LiPF₆). In some examples, the FEC: DEC in the electrolyte 60 has a ratio in a range from 1:1 to 1:9 (e.g., 1:4). In some examples, the electrolyte 60 comprises 1.2 wt % to 2.5 wt % of TFEP (and/or one or more TFEP derivatives). In some examples, the electrolyte 60 comprises 0.5 wt % to 1.5 wt % LiPO₂F₂ (e.g., 1.0 wt % LiPO₂F₂).

In some examples, the electrolyte includes tris(2,2,2-trifluoroethyl) phosphate (TFEP). In other examples, the electrolyte includes a TFEP derivative instead of TFEP and/or in addition to TFEP. In some examples, the TFEP derivatives include phosphate with linear fluorinated side groups. In some examples, the linear fluorinated side groups include tris(2,2,3,3,3-pentafluoropropyl) phosphate, bis(2,2,2-trifluoroethyl) methyl phosphonate, methyl P,P-bis(2,2,2-trifluoroethyl) phosphonoacetate, etc.

In some examples, the cathode active material comprises a high voltage cathode active material. As used herein, high voltage refers to operation at greater than or equal to 4.2V. In some examples, the cathode active material comprises LMR, lithium nickel manganese oxide (LNMO), and/or their blends.

In some examples, the anode active material comprises graphite and one or more materials selected from a group consisting of silicon (Si), silicon/carbon composite, silicon oxide (SiOx), lithium silicon oxide (LiSiOx), and/or their blends.

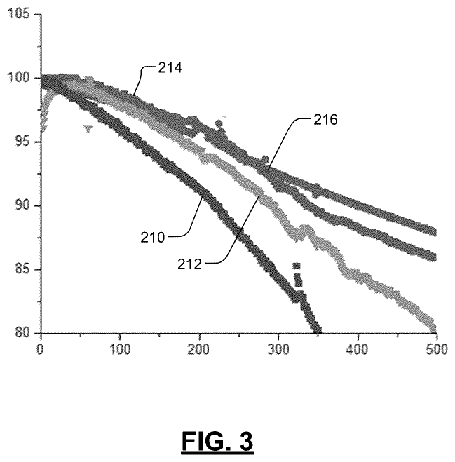

The TFEP is a flame-retarding solvent. In FIG. 2, areal capacity (mAh/cm²) is shown as a function of the number of cycles. The battery cell includes anode active material comprising 10 wt % silicon/carbon composite and 90% graphite. The cathode active material comprises LMR (e.g., 97 wt %). Results are shown for the electrolyte comprising baseline electrolyte at 210. At 212, the electrolyte includes LiPF₆, FEC, DEC and 2% TFEP. At 214, the electrolyte includes LiPF₆, FEC, DEC, 2% TFEP, and 1% LiPO₂F₂. At 216, the electrolyte includes LiPF₆, FEC, DEC, 1% TFEP, and 1% LiPO₂F₂.

In FIG. 3, normalized capacity retention percentage is shown as a function of the number of cycles for the different electrolyte mixtures described in FIG. 2. The voltage window for cycling is from 4.4V to 2V. The voltage window for formation is from 4.5V to 2V. In both FIGS. 2 and 3, using TFEP increases both areal capacity and normalized capacity retention relative to the baseline electrolyte.

The TFEP attaches to a surface of the cathode active material through P-O-transition metal (TM) bonds where one of the trifluoro ethyl (—CH₂CF₃) groups is removed. The TFEP has high solubility in carbonate solvents and contributes to performance at low and/or high temperature conditions. The TFEP includes more fluorine (—F) groups which can repair/reinforce an initial electrode/electrolyte interphase formed from LiPO₂F₂ during cycling.

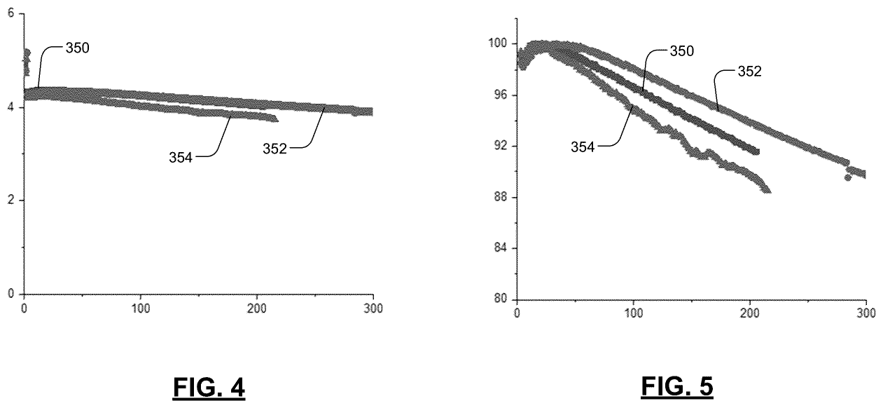

Electrochemical testing is shown in FIGS. 4 and 5. In FIG. 4, the anode active layer comprises 5.5 wt % SiOx and 94.5 wt % graphite. The cathode comprises LMR (e.g., 94 wt %), carbon black (CB) (e.g., 3%), and polyvinylidene fluoride (PVDF) (e.g., 3%).

In FIG. 4, areal capacity is shown for various electrolyte mixtures. At 350, the electrolyte includes LiPF₆, FEC, DEC and 1% wt TFEP. At 352, the electrolyte includes LiPF₆, FEC, DEC and 2% wt TFEP. At 354, the electrolyte includes LiPF₆, FEC, DEC and 3% wt TFEP. In FIG. 5, normalized capacity retention is shown for the samples 350, 352, and 354. FIGS. 4 and 5 demonstrate improved performance of battery cell when the TFEP is in a range from 1.2 wt % to 2.5 wt %.

In some examples, the electrolyte comprises TFEP and/or one or more TFP derivatives and LiPO₂F₂. In some examples, the electrolyte comprise 0.5 wt % to 1.5 wt % LiPO₂F₂ (e.g., 1.0 wt % LiPO₂F₂) and TFEP and/or one or more TFP derivatives.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A battery cell comprising:
C cathode electrodes comprising a cathode current collector and a cathode active material layer, where C is an integer greater than zero;
A anode electrodes comprising an anode current collector and an anode active material layer, where A is an integer greater than zero;
S separators, where S is an integer greater than zero; and
an electrolyte comprising an additive including at least one of tris(2,2,2-trifluoroethyl) phosphate (TFEP) and a TFEP derivative.

2. The battery cell of claim 1, wherein the electrolyte further comprises lithium hexafluorophosphate (LiPF₆).

3. The battery cell of claim 2, wherein the LiPF₆ comprises 0.5 to 1.5 Molar LiPF₆.

4. The battery cell of claim 2, wherein the electrolyte further comprises fluoroethylene carbonate (FEC).

5. The battery cell of claim 4, wherein the electrolyte further comprises diethyl carbonate (DEC).

6. The battery cell of claim 5, wherein the electrolyte includes a ratio of FEC to DEC in a range from 1:1 to 1:9.

7. The battery cell of claim 1, wherein the electrolyte comprises 0.5 wt % to

2. 5 wt % of the at least one of TFEP and the TFEP derivative.

8. The battery cell of claim 1, wherein the TFEP derivative includes phosphate with one or more linear fluorinated side groups.

9. The battery cell of claim 8, wherein the one or more linear fluorinated side groups include one or more materials selected from a group consisting of tris(2,2,3,3,3-pentafluoropropyl) phosphate, bis(2,2,2-trifluoroethyl) methyl phosphonate, and methyl P,P-bis(2,2,2-trifluoroethyl) phosphonoacetate.

10. The battery cell of claim 1, wherein the anode active material layer comprises graphite and one or more materials selected from a group consisting of silicon, silicon/carbon composite, silicon oxide, and lithium silicon oxide.

11. The battery cell of claim 10, wherein the C cathode electrodes have an operating voltage greater than or equal to 4.2V.

12. The battery cell of claim 1, wherein the cathode active material layer includes one or more materials selected from a group consisting of lithium and manganese-rich (LMR) particles and lithium nickel manganese oxide (LNMO) particles.

13. The battery cell of claim 1, wherein the electrolyte further comprises 0.5 wt % to 1.5 wt % LiPO₂F₂.

14. An electrolyte comprising:
lithium hexafluorophosphate (LiPF₆);
fluoroethylene carbonate (FEC);
diethyl carbonate (DEC); and
an additive including at least one of tris(2,2,2-trifluoroethyl) phosphate (TFEP) and a TFEP derivative.

15. The electrolyte of claim 14, wherein the LiPF₆ comprises 0.5 to 1.5 molar per liter LiPF₆.

16. The electrolyte of claim 14, wherein the electrolyte includes a ratio of FEC to DEC in a range from 1:1 to 1:9.

17. The electrolyte of claim 14, wherein the electrolyte comprises 0.5 wt % to 2.5 wt % of the at least one of TFEP and the TFEP derivative.

18. The electrolyte of claim 14, wherein the TFEP derivative includes phosphate with one or more linear fluorinated side groups.

19. The electrolyte of claim 18, wherein the one or more linear fluorinated side groups include one or more materials selected from a group consisting of tris(2,2,3,3,3-pentafluoropropyl) phosphate, bis(2,2,2-trifluoroethyl) methyl phosphonate, and methyl P,P-bis(2,2,2-trifluoroethyl) phosphonoacetate.

20. The battery cell of claim 14, wherein the electrolyte further comprises 0.5 wt % to 1.5 wt % LiPO₂F₂.
